(19) United States
(12) Patent Application Publication
(10) Pub. No.: US 2006/0262686 A1
(43) Pub. Date: Nov. 23, 2006

(54) DIGITAL DATA SLICING CIRCUIT AND SLICING METHOD

(76) Inventor: Sheng-hung Wu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,326

(22) Filed: Sep. 7, 2005

(30) Foreign Application Priority Data
May 17, 2005 (TW) 94115864

(51) Int. Cl. G11B 7/00

(52) U.S. Cl. 369/53.11

(57) ABSTRACT

A digital data slicing circuit and a method for slicing digital data are provided. The digital data slicing circuit comprises a slicer, a phase locked loop (PLL), a data jitter circuit, and a level calculator. Wherein, the slicer receives a RF signal and a slicing level and outputs a digital signal. The PLL provides a PLL clock based on the received digital signal. The data jitter circuit obtains a jitter signal by comparing the digital signal with the PLL clock, and outputs a jitter error signal by performing a jitter calculation with the jitter signal, the digital signal, and the PLL clock. The level calculator receives the jitter error signal and adjusts and outputs the slicing level.

### CROSS-REFERENCE TO RELATED APPLICATION

This application claims the priority benefit of Taiwan application serial no. 94118564, filed on May 17, 2005. All disclosure of the Taiwan application is incorporated herein by reference.

### BACKGROUND OF THE INVENTION

1. Field of the Invention

The present invention relates to a digital data slicing circuit and a slicing method, and more particularly, to a digital data slicing circuit and a slicing method for slicing digital data on jitter sum value (JSV).

2. Description of the Related Art

In order to reduce the transmission of DC component in storing the digital data, several encoding methods such as various theories described in the Compact Disc Standard Red Book (IEC-908) are designed as to have the variance of the digital sum value (DSV) of new codes approach to 0 after the data encoding is ensured.

In general, a higher Run-Length-Limited (RLL) modulation code is commonly used in communication system to limit channel bandwidth. For example, a modulation system with 8-14 plus 3 merging bits is used for Compact Disc (CD), and an 8-16 bits modulation system is used for Digital Versatile Disc (DVD). Unlike other modulation systems, such as the bi-phase modulation system, the binary digital data having an accumulated digital sum value (DSV) is deteriorated by such RLL modulation according to some slicer scheme which searches for the slicing level to make DSV 0. The techniques disclosed in U.S. Pat. Nos. 5,974,088 and 5,548,284 eliminate such effect by accumulating DSV first and then modifying the slicing level. In addition, the technique disclosed in U.S. Pat. No. 6,169,716 eliminates such impact by detecting the phase difference between the extracted clock and the sliced value, and a multiplexing transmission with a conventional DSV slicer is applied therein to obtain more stable slicing.

The binary RF signal received from the transmission channel is sliced, and the clock is extracted and sampled in order to perform demodulation in further data processing. Since the transmission channel is limited, for example by the bandwidth of the optical storage media, in respect of reducing the unit cost of a memory unit, having an RLL modulation code with higher ratio becomes favorable. However, the communication system using the RLL modulation code with higher rate has a problem that the center level of the RF signal is drifted when DSV is being accumulated. In general, the easiest way is to ignore the drift of DSV and modify the slicing level by making DSV=0. If the adjustment speed of the slicing level is not fast enough and there are too many variances of the channel transmission rate, the slicing result may be limited for general applications. However, when the characteristic of channel is deteriorated (e.g., stains or scratches on the surface of the optical disc), the slow response of the slicing level cannot effectively recover the profile-altered data stored around the deteriorated area. Moreover, some random or human-made patterns for a pretty high modulated DSV will conclude an uncorrectable result.

U.S. Pat. Nos. 5,974,088 and 6,169,716 disclose the techniques of compensating DSV or obtaining a slicing level sensor independent of DSV. In the prior art, a precise DSV is required for the slicing level ratio; and if it is not precise enough, the compensation will make more errors.

### SUMMARY OF THE INVENTION

Therefore, it is an object of the present invention to provide a digital data slicing circuit, which is not impacted by digital sum value (DSV) and is capable of obtaining a higher bandwidth when slicing the digital data.

It is another object of the present invention to provide a method for slicing digital data, which eliminates the problem of DC drift described in U.S. Pat. No. 6,169,716 and is not impacted by the phase error of the Phase Locked Loop (PLL).

The present invention provides a digital data slicing circuit. The digital data slicing circuit comprises a slicer, a Phase Locked Loop (PLL), a data jitter circuit and a level calculator. Wherein, the slicer receives an RF signal and a slicing level for outputting a digital signal. The described PLL outputs a PLL clock based on the received digital signal. The data jitter circuit obtains a jitter signal by comparing the digital signal with the PLL clock, and outputs a jitter error signal by performing a jitter calculation with the jitter signal, the digital signal and the PLL clock. Finally, the level calculator receives the jitter error signal for adjusting and outputting the slicing level.

In accordance with a preferred embodiment of the present invention, the slicer mentioned above comprises a digital-to-analog (D/A) converter and a comparator. Wherein, the D/A converter receives the slicing level and converts the received slicing level into an analog signal by performing a D/A conversion. A positive input terminal of the comparator receives the RF signal, and a negative input terminal of the comparator receives the slicing level. In addition, the comparator slices the RF signal based on the slicing level and outputs a digital signal.

In accordance with a preferred embodiment of the present invention, the slicer mentioned above comprises an analog-to-digital (A/D) converter and a comparator. Wherein, the A/D converter receives the RF signal and converts the received RF signal into a digital signal by performing an A/D conversion. A positive input terminal of the comparator receives the digitalized RF signal, and a negative input terminal of the comparator receives the slicing level. In addition, the comparator slices the RF signal based on the slicing level and outputs a digital signal.

In accordance with the preferred embodiment of the present invention, the digital data slicing circuit mentioned above further comprises an alternative level generator and a multiplexer. Wherein, the alternative level generator generates an alternative slicing level or utilizes a general DSV slicer, and the multiplexer switches between the alternative level generator and the level calculator according to a mode selection signal.

In accordance with the preferred embodiment of the present invention, the jitter calculation mentioned above comprises: measuring and determining whether the jitter signal is less than ½ cycle of two contiguous PLL clocks; and selecting either a cycle of zero-cross from the PLL clock to the digital signal or a cycle from the zero-cross of the digital signal to the PLL clock, such that the data jitter circuit selectively outputs the jitter error signal.

The present invention further provides a method for slicing digital data. The method comprises the following steps. First, the slicer receives an RF signal and a slicing level and outputs a digital signal based on the received RF signal and the slicing level. Then, the PLL receives the digital signal and outputs a PLL clock based on the received digital signal. Then, the data jitter circuit receives the digital signal, obtains a jitter signal by comparing the digital signal with the PLL clock, and outputs a jitter error signal by performing a jitter calculation with the jitter signal, the digital signal, and the PLL clock. Finally, the level calculator receives the jitter error signal and adjusts and outputs the slicing level.

In accordance with the preferred embodiment of the present invention, the method of receiving the RF signal and the slicing level and outputs the digital signal based on the received RF signal and the slicing level mentioned above comprises the following steps. First, the D/A converter receives the slicing level and converts the received slicing level into an analog signal by performing a digital-to-analog (D/A) conversion. Then, the comparator slices the RF signal based on the slicing level and outputs the digital signal.

In accordance with the preferred embodiment of the present invention, the method of receiving the RF signal and the slicing level and outputting the digital signal based on the received RF signal and the slicing level mentioned above comprises the following steps. First, the A/D converter receives the RF signal and converts the received RF signal into a digital signal by performing an analog-to-digital (A/D) conversion. Then, the comparator slices the RF signal based on the slicing level and outputs the digital signal.

Since the present invention slices the digital data based on the Jitter Sum Value (JSV), it will not be impacted by digital sum value (DSV) when slicing the digital data; and a higher bandwidth can be obtained. In addition, the problem of DC drift is eliminated, and the phase error of the PLL does not impact the present invention.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a circuit diagram of a digital data slicing circuit according to a preferred embodiment of the present invention.

FIG. 2 schematically shows a circuit diagram of another digital data slicing circuit according to a preferred embodiment of the present invention.

FIG. 3 schematically shows a diagram of the signal waveforms according to a preferred embodiment of the present invention.

FIG. 4 schematically shows a flow chart illustrating a method for slicing digital data according to a preferred embodiment of the present invention.

### DESCRIPTION PREFERRED EMBODIMENTS

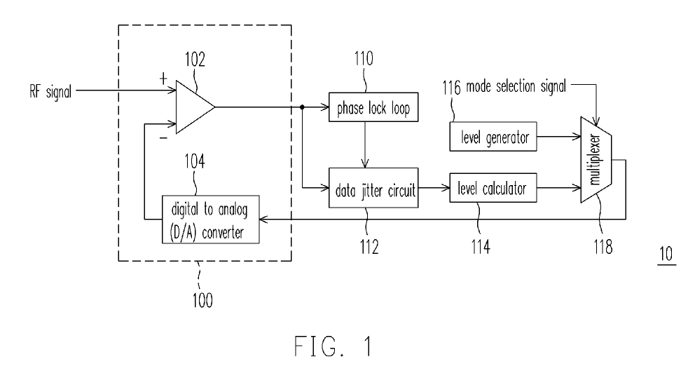

FIG. 1 schematically shows a block diagram of a digital data slicing circuit according to a preferred embodiment of the present invention. In the present embodiment, the digital data slicing circuit 10 comprises a slicer 100, a phase lock loop (PLL) 110, a data jitter circuit 112, a level calculator 114, an alternative level generator 116 and a multiplexer 118. Wherein, the slicer 100 shown in FIG. 1 is an analog slicer.

The slicer 100 comprises a digital to analog (D/A) converter 104 and a comparator 102. Wherein, the D/A converter 104 is electrically coupled to the multiplexer 108 and a negative input terminal of the comparator 102, thus a negative feedback system is formed by cooperating with the multiplexer 118. The D/A converter 104 receives the slicing level from the multiplexer 118, converts the digital slicing level into an analog slicing level, and feeds the analog slicing level to the negative input terminal of the comparator 102. The positive input terminal of the comparator 102 receives an analog RF signal, compares the RF signal with the slicing level, slices the RF signal based on the slicing level, and provides the digital signal to the PLL 110 and the data jitter circuit 112.

Then, the PLL 110 extracts the clock from the digital signal and outputs a PLL clock to the data jitter circuit 112.

The data jitter circuit 112 electrically coupled to the PLL 110 and the comparator 102 performs a jitter calculation with the jitter signal, the PLL clock, and the digital signal based on the PLL clock for measuring the timing jitter signal of the digital signal, and outputs a jitter error signal by comparing the digital signal, and the PLL clock.

Afterwards, the level calculator 114 electrically coupled to the data jitter circuit 112 receives the jitter error signal, and adjusts and outputs the slicing level to the multiplexer 118. The multiplexer 118 select the level calculator 114 or the alternative level generator 116 to output the slicing level based on a mode selection signal. Wherein, the mode selection signal switches the alternative level generator 116 to the JSV (jitter sum value) slicer when the PLL 110 is stable and the JSV slicer has entered into its stable region. From the other perspective, when the JSV has lost its control or when the feedback system is stable, the mode selection signal switches the JSV slicer to the alternative level generator 116.

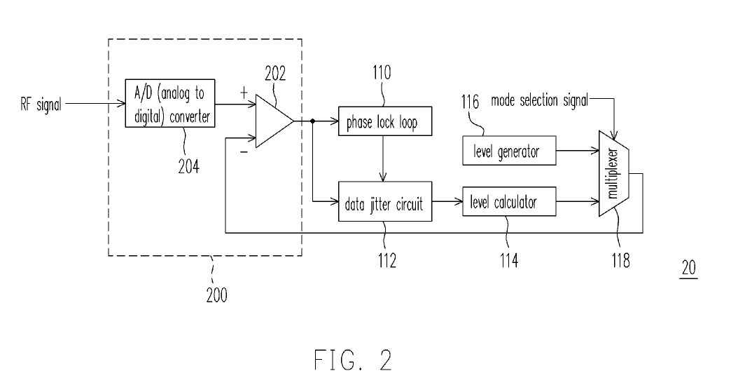

FIG. 2 schematically shows a block diagram of another digital data slicing circuit according to a preferred embodiment of the present invention. The difference of FIG. 2 and FIG. 1 is that the slicer 100 in FIG. 1 is an analog slicer, and the slicer 200 in FIG. 2 is a digital slicer.

In the present embodiment, the slicer 200 in FIG. 2 comprises an A/D (analog to digital) converter 204 and a comparator 202. Wherein, the A/D converter 204 receives an RF signal and converts the received RF signal into a digital signal. The comparator 202 has a positive input terminal and a negative input terminal. The positive input terminal receives the digitalized RF signal, and the negative input terminal receives the slicing level. In addition, the comparator 202 slices the RF signal based on the slicing level and outputs the digital signal.

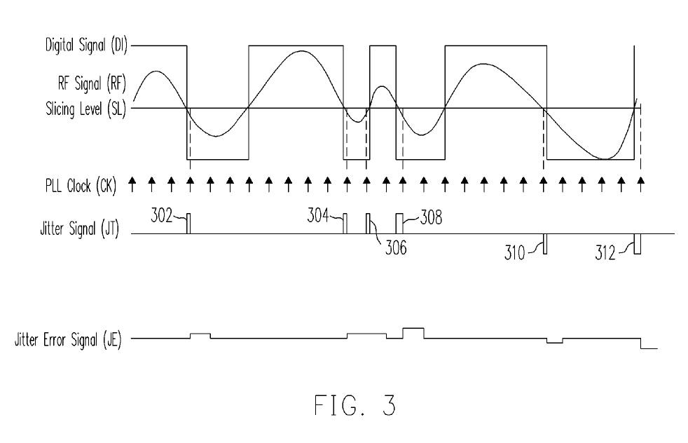

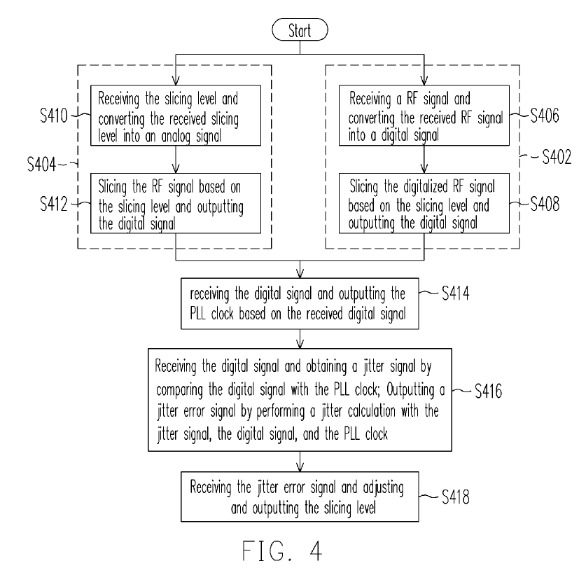

FIG. 3 schematically shows a diagram of the signal waveforms according to a preferred embodiment of the present invention. FIG. 4 schematically shows a flow chart illustrating a method for slicing digital data according to a preferred embodiment of the present invention.

In the present embodiment, the method for slicing digital data comprises the following steps. First, the slicer 200 receives the RF signal (as shown in FIG. 3) and the slicing level (as shown in FIG. 3) and outputs the digital signal based on the received RF signal and the slicing level (S402). Alternatively, the slicer 100 may receive the RF signal and the slicing level and output the digital signal (as shown in FIG. 3) based on the received RF signal and the slicing level (S404).

In step S402, the A/D converter 204 of the slicer 200 receives the RF signal and converts the received RF signal into a digital signal (S406). Then, the comparator 202 slices the digitalized RF signal based on the slicing level (received from the multiplexer 118) and outputs the digital signal (S408).

In step S404, the D/A converter 104 of the slicer 100 receives the slicing level (from the multiplexer 118), converts the received slicing level into an analog signal, and feeds the analog slicing level into the negative input terminal of the comparator 102 (S410). Then, the comparator 102 slices the RF signal based on the slicing level and outputs the digital signal (S412).

Wherein, if the slicing level is decreased, the slicing signal extends its positive cycle. In the present embodiment, the original analog RF signal RF is sliced into the digital signal DI by using the slicing level SL.

Afterwards, the PLL 110 receives the digital signal and outputs the PLL clock (as shown in FIG. 3) based on the received digital signal (S414). The data jitter circuit 112 obtains a jitter signal by comparing the digital signal with the PLL clock, and outputs a jitter error signal by performing a jitter calculation with the jitter signal, the digital signal, and the PLL clock.

Then, the level calculator 114 obtains a jitter signal JT by comparing the PLL clock CK with the digital signal DI. It is to be noted that the jitter signal JT in FIG. 3 is not a real signal as for a causal system. If a clock with a higher frequency exists, the cycles from clock to clock, from clock to DI zero-cross, and from DI zero-cross to clock can be measured with such clock, and it is possible to compare and determine whether these cycles are less than ½ of such clock or less than ½ of the cycle from clock to clock. When the comparison result is true, the valid jitter error signal JE is measured, and the slicing level is adjusted by the level calculator. When the head of the positive cycle is before the clock pulse or when the tail of the positive cycle is subsequent to the clock pulse, the data jitter is positive. When the head of the positive cycle is subsequent to the clock pulse or when the tail of the positive cycle is before the clock pulse, the data jitter is negative. On the other hand, when the head of the negative cycle is before the clock pulse or when the tail of the positive cycle is before the clock pulse, the data jitter is negative. When the head of the negative cycle is subsequent to the clock pulse or when the tail of the negative cycle is before the clock pulse, the data jitter is positive (S416). In addition, the scheme mentioned above is also known as a jitter Sum Value (JSV).

Then, the level calculator 114 converts the data jitter signal into the slicing level, such that a stable negative feedback system is formed. Accordingly, if it is known that the slicing level is rather higher detected by JSV, a lower slicing level is output by the level calculator 114; or when the detection result is unreliable or can be ignored, the level calculator 114 maintains the current slicing level (S418). The level calculator 114 can also provides the statistic information of JSV by calculating low-pass, total number of windows, pattern characteristics, or other factors such as negative feedback signal.

In summary, in the digital data slicing circuit and the method for slicing digital data provided by the present invention, the digital data is sliced on JSV. Accordingly, the present invention is not impacted by DSV when slicing the digital data, thus a higher bandwidth can be obtained. In addition, the problem of DC drift is eliminated, and the phase error of the PLL does not impact the present invention.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A digital data slicing circuit receiving an RF signal, and the digital data slicing circuit comprising:
a slicer receiving the RF signal and a slicing level for outputting a digital signal;
a Phase Locked Loop (PLL), electrically coupled to the slicer for receiving the digital signal and outputting a PLL clock based on the received digital signal;
a data jitter circuit, electrically coupled to the slicer and the PLL for receiving the digital signal and the PLL clock and obtaining a jitter signal by comparing the digital signal with the PLL clock, and outputting a jitter error signal by performing a jitter calculation with the jitter signal, the digital signal, and the PLL clock; and
a level calculator, electrically coupled to the data jitter circuit for receiving the jitter error signal and adjusting and outputting the slicing level.

2. The digital data slicing circuit of claim 1, wherein the slicer comprises:
a digital-to-analog (D/A) converter for receiving the slicing level and converting the received slicing level into an analog signal; and
a comparator having a positive input terminal and a negative input terminal, wherein the positive input terminal receives the RF signal, the negative input terminal receives the slicing level, and the comparator slices the RF signal based on the slicing level and outputs the digital signal.

3. The digital data slicing circuit of claim 1, wherein the slicer comprises:
an analog-to-digital (A/D) converter for receiving the RF signal and converting the received RF signal into a digital signal; and
a comparator having a positive input terminal and a negative input terminal, wherein the positive input terminal receives the digitalized RF signal, the negative input terminal receives the slicing level, and the comparator slices the RF signal based on the slicing level and outputs the digital signal.

4. The digital data slicing circuit of claim 1, further comprising:
an alternative level generator for generating an alternative slicing level; and
a multiplexer, electrically coupled to the alternative level generator and the level calculator for switching between the alternative level generator and the level calculator according to a mode selection signal.

5. The digital data slicing circuit of claim 1, wherein when a result from the jitter calculation is less than ½ cycle of two contiguous PLL clocks, the jitter signal is outputted.

6. The digital data slicing circuit of claim 5, wherein the jitter calculation measures a cycle of zero-cross from the PLL clock to the digital signal.

7. The digital data slicing circuit of claim 6, wherein the jitter calculation further measures a cycle from the zero-cross of the digital signal to the PLL clock.

8. A method for slicing digital data, comprising:
receiving an RF signal and a slicing level and outputting a digital signal based on the received RF signal and the slicing level;
receiving the digital signal and outputting a PLL clock based on the received digital signal;
receiving the digital signal and the PLL clock, obtaining a jitter signal by comparing the received digital signal with the PLL clock, and outputting a jitter error signal by performing a jitter calculation with the jitter signal, the PLL clock, and the digital signal; and
receiving the jitter error signal and adjusting and outputting the slicing level.

9. The method for slicing digital data of claim 8, wherein the step of receiving the RF signal and the slicing level and outputting the digital signal based on the received RF signal and the slicing level comprises:
receiving the slicing level, and converting the slicing level into an analog signal; and
slicing the RF signal based on the slicing level and outputting the digital signal.

10. The method for slicing digital data of claim 8, wherein the steps of receiving the RF signal and the slicing level and outputting the digital signal based on the received RF signal and the slicing level comprise:
receiving the RF signal, and converting the RF signal into a digital signal; and
slicing the RF signal based on the slicing level and outputting the digital signal.

11. The method for slicing digital data of claim 8, wherein when a result from the jitter calculation is less than ½ cycle of two contiguous PLL clocks, the jitter signal is outputted.

12. The method for slicing digital data of claim 11, wherein the jitter calculation measures a cycle of zero-cross from the PLL clock to the digital signal.

13. The method for slicing digital data of claim 12, wherein the jitter calculation further measures a cycle from the zero-cross of the digital signal to the PLL clock.
